(19) United States
(12) Patent Application Publication
(10) Pub. No.: US 2001/0041994 A1
(43) Pub. Date: Nov. 15, 2001

(54) Visitor data management system and method thereof

(76) Inventor: Young Bae Kim, Seoul (KR)

Correspondence Address: MAREK ALBOSZTA, LUMEN INTELLECTUAL PROPERTY SERVICES, SUITE 110, 45 CABOT AVENUE, SANTA CLARA, CA, 95051, US

(21) Appl. No.: 09/769,951

(22) Filed: Jan. 24, 2001

(30) Foreign Application Priority Data
Feb. 1, 2000 (KR) 2000-0004967

(51) Int. Cl. G06F 17/60

(52) U.S. Cl. 705/5

(57) ABSTRACT

A visitor data management system and method thereof provides for real-time collecting and sorting of visitor data according to the visits of a visitor to individual booths of an event such as a fair, exhibition, convention, specialty exhibition or the like, and supplying the data thus obtained to a booth operator participating in the event. The system includes a visitor identification medium, preferably, an RF smart card, supplied to the visitor and bearing recorded visitor data, an RF smart card reader installed at each booth to read the visitor data, a host computer for processing the visitor data and data corresponding to the respective booths based on the visitor data input from the RF smart card readers, and an apparatus for transmitting the visitor data to each of the booths. Statistics on the attendance status of all event visitors can be recorded by the exact date and time and the corresponding booth, freeing booth operators from laborious record keeping.

### BACKGROUND OF THE INVENTION

1. Field of the Invention

The present invention relates to a system and method for managing visitor data pertaining to an individual visitor to an event such as a fair, exhibition, convention, specialty exhibition, or the like, and in particular, to a system and method for the management of visitor data in real time using a visitor identification medium such as an RF smart card issued and monitored by the event sponsor or sponsors.

2. Discussion of the Related Art

Often, a large-scale event such as a fair, exhibition, convention, specialty exhibition, or the like utilizes an advance registration system, whereby individual visitors to the event supply personal data, e.g., name, title, and business affiliations, to the event sponsor or sponsors in order to become registered. Events such as these are generally made up of a variety of internal sites called booths, which are typically operated by private enterprises separate from the event sponsors.

In such a registration system, personal data of a visitor is collected and recorded through an application system. Thus, a registered visitor may be issued, for example, an identification card bearing the visitor's name and perhaps a photograph and other relevant information, which may be picked up at a reception desk of the event to be retained by the visitor during the visit. As a visitor bearing such an identification card visits the various booths, the identification card is presented at each booth so that the respective booth operators may later compile a database based on the individual visits of each registered visitor.

In the above-described system, however, the visitor is inconvenienced during the event by repeated requests from booth operators to supply personal information. The visitor often feels obliged to write down information into a guest book or the like, and is further inconvenienced by such obligations. Moreover, after the close of the event, further manpower is necessary to collect, compile, manage, and evaluate the visitor data, which burdens the booth operators.

To overcome these problems, a visitor data management system using a barcode and barcode reader has been proposed, whereby a medium bearing a barcode containing recorded visitor data is provided for each visitor before entering or upon entering the event and the barcodes are read at the respective booths. The barcode system, however, is slow and cumbersome, taking two seconds or longer for each instance of reading recorded data, and suffers from poor reliability with an error rate of about 1%. In addition, each booth must be equipped with a laser barcode reader, which burdens the booth operators with much added expense, and the barcode media, a further added cost, is ultimately discarded as a useless item of waste, adding to the waste generated by the event sponsors.

Therefore, a convenient and efficient system is needed for enabling the booth operators at an event to collect, compile, manage, and evaluate visitor data and for enabling visitor access to the data.

### SUMMARY OF THE INVENTION

Accordingly, the present invention is made in order to solve the problems described above.

An object of the present invention is to provide an efficient and accurate system and method for managing visitor data.

Therefore, in order to accomplish the above objects of the present invention, there is provided a method for managing data pertaining to a visitor to an event hosting a plurality of booths, using a host computer as a server for storing and processing visitor data. The method comprises the steps of inputting and registering data on a booth operator and on the visitor to the server; issuing to the visitor a visitor identification medium containing recorded visitor data, and issuing to an operator of each booth a designated input device for reading the visitor identification medium; checking and registering an event attendance status of the visitor by use of the visitor identification medium; reading the recorded visitor data from the visitor identification medium and transmitting the read data to the server for registration, when the visitor visits a predetermined booth; sorting the data transmitted to the server according to predetermined criteria; and distributing the sorted data in real time to the visitor and the operators of the booths on demand.

In order to accomplish another aspect of the present invention, there is provided a visitor data management system for managing data pertaining to a visitor to an event hosting a plurality of booths. The system comprises means for inputting visitor data; means for issuing a visitor identification medium to the visitor, based on the visitor data input from the inputting means; a reader installed at each booth for inputting visitor attendance information; and a host computer, connected via a network to the inputting means, the issuing means, and the reader, for receiving and storing the visitor data from the inputting means and having a pre-stored program for processing the stored visitor data.

In the present invention, the visitor identification medium is an RF card and the reader is an RF card reader. Once manufactured, the RF smart card can be reused indefinitely, and since radio frequency transmission and reception is used, errors are greatly reduced and reading speed is twenty times faster than that of a barcode system.

### BRIEF DESCRIPTION OF THE DRAWINGS

FIG. 1 is a schematic block diagram showing a visitor data management system according to the present invention.

FIG. 2 is a schematic flow chart showing a general process flow in connection with visitor registration and overall operation of the system shown in FIG. 1.

FIG. 3 is a schematic block diagram of the visitor identification medium shown in FIG. 1.

### DETAILED DESCRIPTION OF THE PREFERRED EMBODIMENT

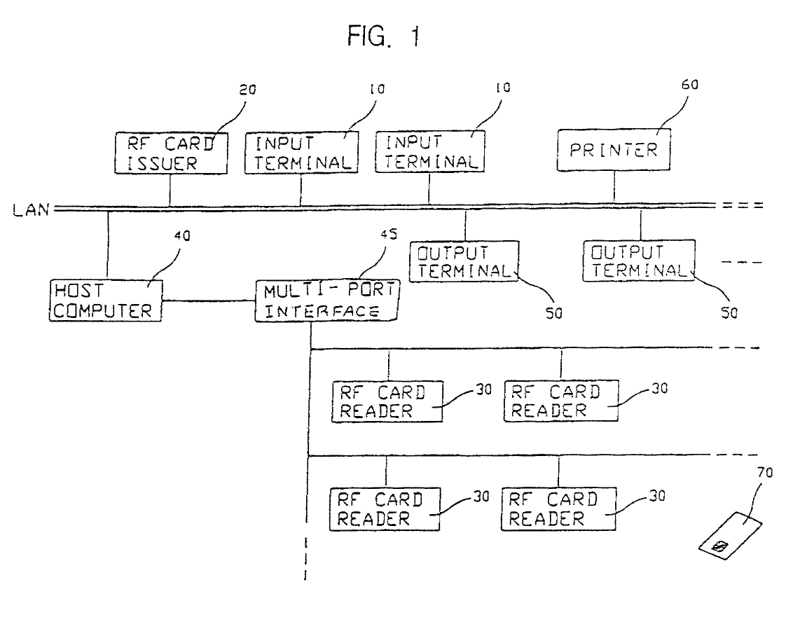

Referring to FIG. 1, the visitor data management system according to the present invention comprises a plurality of input terminals 10 for inputting visitor data; an RF card issuer 20 for programming (recording) a visitor identification medium 70 with visitor data; a plurality of RF card readers 30 for reading the visitor data recorded on the visitor identification medium 70; a host computer 40, acting as a server, having a pre-stored program for processing visitor data input by the data input terminals 10 as well as booth operator data; a multi-port interface unit 45 installed between the host computer 40 and the RF card readers 30; a plurality of output terminals 50 (e.g., computer) connected with the host computer 40 for showing or outputting requested data, including search results or complied visitor data, whereby a visitor or the user can monitor registration status or other such data stored therein; and at least one printer 60 (or similar output device). The above-described elements of the visitor data management system are interconnected by a communication network such as a local area network (LAN). The communication network may also be embodied by a wide area network (WAN) or an open network such as the Internet.

The input terminals 10 are, for example, a computer installed at one or more reception areas of the event or a computer installed remotely, for example, in a home or office, so that visitor data and booth operator data may be received from the input terminals 10 in advance of a visitor's arrival at the event. The remotely installed computers may be connected with the host computer 40 through the Internet by using TCP/IP protocol. Thus, databases for visitor and booth operator information may be compiled and stored in the host computer 40 before the event.

The RF card issuer 20 receives visitor data via the input terminals 10 and/or the host computer 40 and issues the visitor identification medium 70 by programming the medium with visitor data, which includes an identification code. The visitor identification medium 70 is preferably a contactless smart card, hereinafter referred to as an RF card.

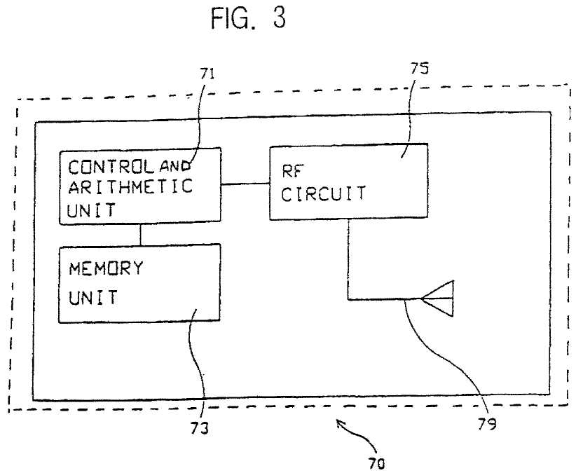

As shown in FIG. 3, the RF card 70 comprises a control and arithmetic unit 71, a memory unit 73 for storing the visitor data, and an RF circuit 75 for transmitting data via and an antenna 75. The control and arithmetic unit 71 and memory unit 73 are similar to those of a smart card having contacts. In the RF card 70, the power for driving the internal circuits are is realized by an electromagnetic coupling of an internally installed coil, and electromagnetic induction is used to communicate with interface devices, e.g., the RF card readers 30. Visitor data input to the RF card 70 from the RF card issuer 20 is stored the memory unit 73, and the stored data is transmitted to an RF card reader 30.

The RF card readers 30, which are installed at the gates of the event as well as in every booth in the event, receive stored visitor data from the RF card 70 by way of electromagnetic induction.

The host computer 40 is connected to the input terminals 10, the RF card issuer 20, the output terminals 50, and the printer 60 via a network, and is also connected to the multi-port interface 45. The multi-port interface 45 acts as a mediating terminal between the host computer 40 and the plurality of RF card readers 30 to enable intercommunication between, for example, conflicting protocols, such as a host computer using RS 232 protocol and an RF card reader using RS 422 protocol.

The output terminals 50 have the same composition as the input terminals 10 but serve a different purpose. The output terminals 50 are typically installed at a reception area (gate) of the event, but may be embodied as a remotely installed computer. The output terminals 50 enable a visitor or booth operator to search and retrieve information (e.g., current event-wide attendance figures or a visitor list per booth) from the host computer 40.

The printer 60 outputs hard copies (printed paper) of visitor data obtained via the network.

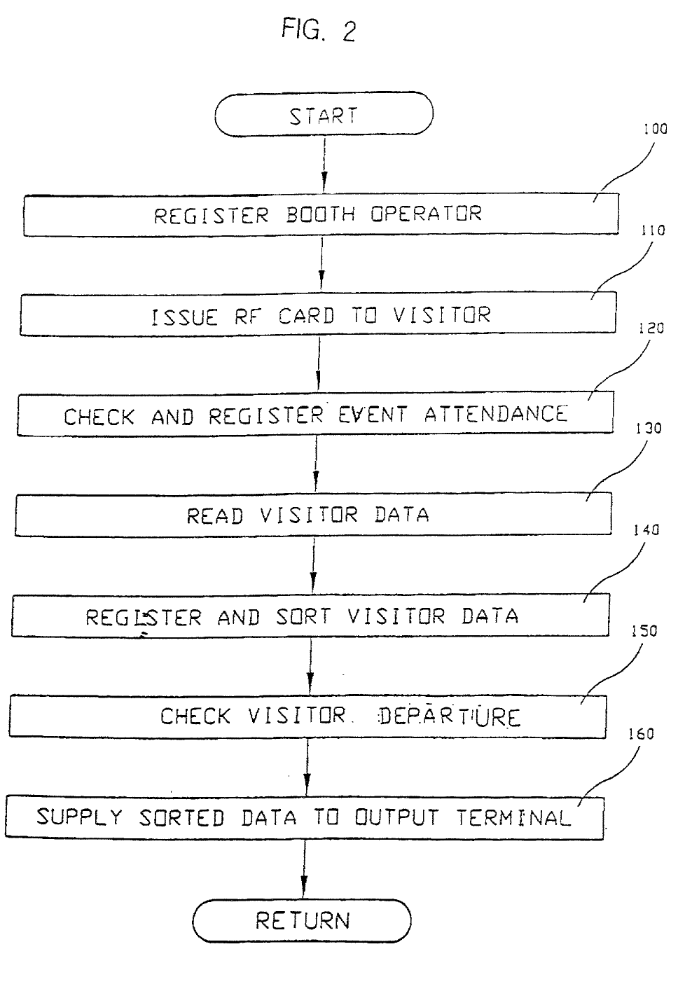

The operation of the system of FIG. 1 will now be explained in conjunction with the flow chart of FIG. 2.

Referring to FIG. 2, in step 100, booth operator data is input to the host computer 40, with an identification code being assigned to each booth operator. Thus, each of the RF card readers 30 is programmed with a booth operator identification code corresponding to each booth, and the programmed RF card reader 30 is provided for each booth.

In order to receive an RF card, a visitor applies for registration, say, at a reception area of the event, by providing personal information. Thus, in step 110, the event sponsor (i.e., a user) inputs a visitor's personal data in the host computer 40 and issues a visitor identification medium. Preferably, the visitor identification medium is an RF card 70 containing recorded visitor data and capable of communicating with an RF card reader 30 by radio waves. The application may also be made via network communication, using a personal computer or over the Internet.

When issuing the RF card 70, the user simply inputs to the host computer 40 an identification code corresponding to each application, without inputting detailed visitor data. That is, the user first issues an RF card 70 to a visitor and then inputs the detailed visitor data based on information provided in the application. Thus, by inputting the identification code, the detailed visitor data of the application is automatically stored in a database file located in the host computer 40.

Once issued the visitor identification medium, i.e., the RF card, a visitor registers in step 120 his or her admission to the event through an RF card reader 30 located at the main entrance using the RF card. A similar card reader is provided at each booth, and the visitor simply lets the reader recognize (read) his or her card upon visiting any given booth. The card reader 30 transmits the thus input information, such as the identification code and the date and time of entrance, to the host computer 40.

Subsequently, the host computer 40 reads and checks in step 130 cumulative data representing, among other things, the number of registered visitors at a given point in time, by using the data input by the visitors. Thus, at a booth provided with one of the RF card readers 30, when a visitor uses a programmed RF card 70 to input his or her identification code into an RF card reader 30, the RF card reader 30 reads and stores the identification code as the RF card 70 is passed over the reader's input in close proximity. The RF card 70 is used in the same manner upon the visitor's departure from the event, whereupon the RF card 70 is forfeited at a main exit of the event.

In step 140, the host computer 40, being connected with each of the RF card readers 30 via a network, receives the input identification code (visitor data), recognizes the input visitor data, and selects for processing that data having a matching identification code. This process can be realized by various physical methods, which offers great flexibility. For example, the user may input into a database the identification code of a booth operator or a visitor; the identification code of a visitor received via an RF card reader 30 may be input into a separate visitor database or a separate database for each booth operator; or specific visitor or visitation data may be recorded as desired. In step 150, upon or after departure, the host computer 40 verifies a visitor's departure by receiving the input identification code (visitor data) and recognizing the input visitor data from an RF card reader 30 installed at the gate of the event.

On the other hand, besides user requests, a visitor or booth operator may request data at any time in step 160, even after the visitor has left the event and the event is closed, and the requested data is provided by output terminals 50 in real time. The retrieved data may also be faxed or be placed on a bulletin board of the server.

Should an event span several days and the visitation by a given visitor occurs on more than one day, the visitor is issued an RF card 70 bearing the same identification code whenever the visitor returns.

According to an embodiment of this invention, the management system comprises the data input terminals 10 for inputting visitor data, the host computer 40 for storing and processing the input visitor data, and the data output terminals 50 for providing the stored and processed data as desired. Also, any one of the data input terminals 10 may be one installed at the event or one installed remotely at any cite having Internet access. Thus, according to the present invention, a visitor can submit an application via the Internet by, for example, connecting to the website of one of the booth operators of an event.

Accordingly, the visitor data management system of the present invention is advantageous in that visitor data may be gathered long before the event and accessed long after the event. In receiving an application, visitor data is input to the host computer 40, and the identification code of the application is input into an RF card 70, which is promptly issued to the applicant with no further application needed at the time of visiting the event. The data is thereafter managed (processed) on the basis of the identification code. Then, when a visitor visits a booth, the visitor uses the issued RF card 70 at any of the RF card readers 30 installed at the booths, and the identification codes of the RF card reader 30 and the RF card 70 are sent to the host computer 40.

Furthermore, the identification code of the RF card reader 30 coincides with that of the database of the booth operator stored in the host computer 40. As the result, two kinds of data can be interconnected, and various connecting methods are herein suggested. For example, a visitor's identification code may be input to the database of a booth operator or vice versa, and both methods may be used at the same time. That is, when a booth operator requests data on a specific visitor, the host computer transmits the stored data corresponding to the identification code stored in a booth operator's database, but when a visitor requests data on a booth operator, the host transmits to an output device the data corresponding to the identification code of the booth operator.

On the other hand, if a time stamping method is incorporated, the host computer 40 may supply useful data sorted by time, day, or other standard, and the data may be transmitted anywhere via a terminal, fax, telecommunication, etc. In this case, the terminal is connected to a host computer through a LAN system or the Internet. Thus, visitor data is available to the booth operators in real time, even before the event closes.

As described above, according to the visitor data management system of the present invention, an RF smart card is issued promptly and processed visitor data is supplied in real time, to assist booth operators in effective marketing strategy and management. In addition, a visitor has access to information about a specific booth operator in real time, by contacting the host computer at any time during an event or after the event has closed.

What is claimed is:

1. A method for managing data pertaining to a visitor to an event hosting a plurality of booths, using a host computer as a server for storing and processing visitor data, said method comprising the steps of:
inputting and registering data on a booth operator and on the visitor to the server;
issuing to the visitor a visitor identification medium containing recorded visitor data, and issuing to an operator of each booth a designated input device for reading the visitor identification medium;
checking and registering an event attendance status of the visitor by use of the visitor identification medium;
reading the recorded visitor data from the visitor identification medium and transmitting the read data to the server for registration, when the visitor visits a predetermined booth;
registering and sorting the data transmitted to the server according to predetermined criteria; and
distributing the sorted data in real time to the visitor and the operators of the booths on demand.

2. The method as claimed in claim 1, wherein the visitor identification medium is an RF smart card.

3. The method as claimed in claim 1, wherein the reader is an RF smart card reader.

4. A visitor data management system for managing data pertaining to a visitor to an event hosting a plurality of booths, said system comprising:
means for inputting visitor data;
means for issuing a visitor identification medium to the visitor, based on the visitor data input from said inputting means;
a reader installed at each booth for inputting visitor attendance information; and
a host computer, connected via a network to said inputting means, said issuing means, and said reader, for receiving and storing the visitor data from said reader and having a pre-stored program for processing the stored visitor data.

5. The system as claimed in claim 4, further comprising means for outputting data processed by said host computer.

6. The system as claimed in claim 4, wherein the visitor identification medium is an RF smart card.

7. The system as claimed in claim 4, wherein said reader is an RF smart card reader.
